(19) United States
(12) Patent Application Publication
(10) Pub. No.: US 2021/0239828 A1
(43) Pub. Date: Aug. 5, 2021

(54) SYSTEM, METHOD AND COMPUTER PROGRAM PRODUCT FOR IMPROVED RADAR-BASED OBJECT RECOGNITION

(71) Applicant: Veev Group, Inc., San Mateo, CA (US)

(72) Inventors: Mati COHEN, Ganei Tikva (IL); Binyamin GIL, Rehovot (IL); Israel Jay KLEIN, Kfar Saba (IL)

(21) Appl. No.: 17/166,234

(22) Filed: Feb. 3, 2021

Related U.S. Application Data
(60) Provisional application No. 62/969,187, filed on Feb. 3, 2020.

(51) Int. Cl. G01S 13/90; G06N 20/20; G01S 13/86

(52) U.S. Cl. CPC G01S 13/9027; G01S 13/9011; G01S 13/867; G06N 20/20

(57) ABSTRACT

A method for generating data regarding individuals in an area of interest including operating a radar system which may be deployed in the area of interest, to provide a radar image including raw radar data; and/or using a hardware processor configured to store a trained model for analyzing the radar image, thereby to generate object recognition data, wherein the raw radar data generated by the radar system both undergoes signal processing, thereby to generate processed radar data which is used for said training, and is used directly, without signal processing, for training said model.

### REFERENCE TO CO-PENDING APPLICATIONS

Priority is claimed from U.S. Provisional Patent Application No. 62/969,187 entitled “System, method and computer program product for improved radar-based object recognition” and filed Feb. 3, 2020, the disclosure of which application is hereby incorporated by reference.

### FIELD OF THIS DISCLOSURE

The present invention relates generally to radar, and more particularly to radar-based object recognition.

### BACKGROUND FOR THIS DISCLOSURE

The use of radar systems to identify various objects is known.

In recent years there has been an increased use of low power millimeter wave radars for various commercial applications. For example, modern cars employ such radars to automatically control velocity by sensing other cars in their immediate surroundings. In some cases, such radars are being used for home applications, such as counting the number of individuals entering a specific space.

Machine learning-based object recognition and deep learning-based object recognition, e.g. using data generated by radar systems, are known, e.g. as described in:
arxiv.org/pdf/1801.08558.pdf
www.adv-radio-sci.net/10/45/2012/ars-10-45-2012.pdf
towardsdatascience.com/deep-learning-and-sar-applications-81ba1a319def.

Ensemble learning is known. Types of ensembles include a Bayes optimal classifier, bootstrap aggregating (bagging), boosting, Bayesian parameter averaging, Bayesian model combination, bucket of models, and stacking.

Feature extraction is known. As described in en.wikipedia.org/wiki/Feature_extraction, “Many data analysis software packages provide for feature extraction and dimension reduction. Common numerical programming environments such as MATLAB, SciLab, NumPy and the R language provide some of the simpler feature extraction techniques (e.g. principal component analysis) via built-in commands. More specific algorithms are often available as publicly available scripts or third-party add-ons. There are also software packages targeting specific software machine learning applications that specialize in feature extraction”.

Regarding radars in general, they are typically either based on some time domain or frequency domain signal processing techniques. Time domain signal processing states that there are direct time based measurements of the target object. For example, if an electromagnetic energy pulse is transmitted by the radar, and after a while the corresponding echo (the result of a transmitting wave “hitting” the target object) is received by the radar, the time difference between transmission and reception corresponds to the round trip wave propagation delay (the time it took the electromagnetic wave to travel to the target object and back to the radar).

In frequency domain signal processing, measurements such as distance, velocity, or, as previously described, are indirectly computed by analyzing the electromagnetic spectrum of the received environment. Typically, the concept of an echo (inherently time domain based) is replaced by a process which more resembles a frequency scan and the related response of the environment, for example, transmitting a continuous sinusoidal wave at a certain frequency. A perfect reflection is also a sinusoidal wave at the same frequency (if the target object is not moving—hence there is no Doppler shift) with some amplitude attenuation and phase shift (proportional to the frequency and the distance). Changing the frequency or transmitting different frequency sinusoidal waves at once (multi tone) enables a deeper analysis of the surrounding environment, as discussed.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide improved object recognition utilizing a hybrid, time- and frequency-domain approach with radar systems.

Certain embodiments seek to provide improved object recognition utilizing a time domain approach with radar systems.

Certain embodiments seek to provide improved object recognition utilizing a frequency domain approach with radar systems.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A method for generating data regarding individuals in an area of interest including all or any subset of the following:

operating a radar system, which may be deployed in the area of interest, to provide a radar image including raw radar data; and/or

using a hardware processor configured to store a trained model for analyzing the radar image, thereby to generate object recognition data,

wherein the raw radar data generated by the radar system typically both
undergoes signal processing, which may include generating processed radar data which may be used for the training, and
is used for training the model, directly and/or without signal processing.
The model may comprise a machine learning or deep learning model.

Embodiment 2. A method according to any of the preceding embodiments wherein the signal processing is performed only every N measurement cycles, thereby to reduce computational effort by a factor of N.

Embodiment 3. A method according to any of the preceding embodiments wherein the training includes using a training data set which includes:

“raw” data which has not undergone the signal processing, for every measurement cycle of the radar system, and the processed radar data, from the processed and constructed source, for only one of every N measurement cycles of the radar system.

Embodiment 4. A method according to any of the preceding embodiments wherein the training includes using a training data set which includes:

“raw” data which has not undergone the signal processing, for only one of every M measurement cycles of the radar system; and

the processed radar data, from the processed and constructed source, for only one of every N< >M measurement cycles of the radar system, with a cycle shift K relative to the M measurement cycles.

Embodiment 5. A method according to any of the preceding embodiments and also comprising using external sensor measurement to enrich the data.

Embodiment 6. A method according to any of the preceding embodiments wherein the radar system comprises a millimeter wave radar whose inherent spatial resolution is coarser than the inherent spatial resolution of an optical camera.

Embodiment 7. A method according to any of the preceding embodiments wherein the data comprises a determination of whether or not a given detected individual appears on a given whitelist.

The determination may or may not be binary. For example, fuzzy logic may be used to yield a non-binary determination.

Embodiment 8. A method according to any of the preceding embodiments wherein a physical camera is used allowing for correlation between images and radar scans.

Embodiment 9. A method according to any of the preceding embodiments, wherein 2D construction of the 2D constructed radar image is performed only every N measurement cycles, thereby to reduce computational resources required for generating data from the radar image.

Embodiment 10. A method according to any of the preceding embodiments wherein the radar image comprises at least one of:

a 3D constructed radar image; and

a 2D constructed radar image.

Embodiment 11. A method according to any of the preceding embodiments wherein 3D construction of the 3D constructed radar image is performed only every N measurement cycles, thereby to reduce computational resources required for generating data from the radar image.

Embodiment 12. A method according to any of the preceding embodiments wherein Ensemble Learning is used to combine raw and constructed radar data.

Embodiment 13. A method according to any of the preceding embodiments wherein the raw data being combined comprises at least one spectral measurement including at least one power measurement at a specific frequency.

Embodiment 14. A method according to any of the preceding embodiments wherein the constructed data being combined comprises at least one spatial measurement including at least one intensity measurement at a specific pixel.

Embodiment 15. A method according to any of the preceding embodiments wherein both power measurements in the frequency domain are used together with intensity measurements of different pixels representing a 2D area.

Embodiment 16. A method according to any of the preceding embodiments wherein both power measurements in the frequency domain and intensity measurements of different pixels representing some 2D area are used together for establishing the model.

Embodiment 17. A computer program product, comprising a non-transitory tangible computer readable medium having computer readable program code embodied therein, the computer readable program code adapted to be executed to implement a method for generating data regarding individuals in an area of interest including:

Receiving a radar image including raw radar data, generated by a radar system deployed in the area of interest,

wherein the raw radar data generated by the radar system both

undergoes signal processing, thereby to generate processed radar data which is used for the training, and

is used directly, without signal processing, for training a trained model, and

using the trained model for analyzing the raw radar data, thereby to generate object recognition data.

Embodiment 18. A system comprising at least one processor configured to carry out the operations of:

Receiving a radar image including raw radar data, generated by a radar system deployed in the area of interest,

wherein the raw radar data generated by the radar system both
undergoes signal processing, thereby to generate processed radar data which is used for the training, and
is used directly, without signal processing, for training a trained model, and

using the trained model for analyzing the raw radar data, thereby to generate object recognition data.

Embodiment 19. A method according to any of the preceding embodiments wherein sensor data is used for label tagging the radar measurements for the data collection and training phase of at least one algorithm (e.g. machine learning or deep learning).

Embodiment 20. A method according to any of the preceding embodiments wherein, to know that sensor measurements of a specific individual are related to the radar measurements of the same person, coupling is achieved by event synchronization.

Embodiment 21. A system according to any of the preceding embodiments which includes a sensor e.g. weight sensor whose outputs are combined with temporally adjacent outputs of the at least one processor, thereby to yield classification of detected events as presence of an identified one of, or none of, plural objects on a whitelist, at a level of accuracy exceeding an accuracy level which would result from using the system alone, without the sensor, for the classification.

Embodiment 22. A system according to any of the preceding embodiments which includes e.g. an optical camera with face recognition functionality which provides a label identifying a recognized face which can be used to tag radar measurements (or radar data) generated by the radar system, thereby to yield tagged training data to be used during the training.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 is a simplified block diagram illustration of Frequency-Modulated Continuous Wave radar system useful according to embodiments of the invention described herein.

FIGS. 2-4 are simplified block diagram illustrations of methods for generating radar-based identification results e.g. using the system of FIG. 1, in accordance with respective first, second and third embodiments of the present invention.

FIG. 5 is a simplified pictorial illustration of example antenna structures each of which may be used in conjunction with any embodiment and process shown and described herein.

FIGS. 6a and 6b are useful in understanding respective 2D/3D construction embodiments each of which may be used in conjunction with any embodiment and process shown and described herein.

The systems and methods herein each typically comprise all or any subset of the illustrated blocks, suitably ordered e.g. as shown or presented; the blocks may also be suitably combined between the embodiments specifically illustrated by way of example, unless otherwise indicated herein.

In the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP, or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

For use cases which involve identification and recognition of individuals, high resolution images may be required, and conventional optical cameras are typically used. Use of millimeter wave radars may be considered as an alternative. However, there are some practical drawbacks if radars are considered to directly replace cameras. Although the radar operating frequency may be extremely high, while supporting very high bandwidth signals, the spatial resolution may still be limited to several centimeters, hence only coarse images may be obtained. Therefore it may be useful or even necessary to obtain any available measurement data that can increase the likelihood of correct identification not limited to traditional image features.

In order to, e.g., resolve resolution issues in such cases, attempts may be made to measure additional relevant information and allow for repeated measurements (e.g., noise reduction by averaging several continuous measurements). For example, the full body aspects of an individual may be addressed. Typically, instead of limiting the recognition process to specific physical appearance features (e.g., facial) which typically can, at least to some extent, uniquely identify an individual, additional features such as height and/or posture and/or specific movements or gestures used by the individual may be used, alternatively or in addition. Repeating the measurement process, e.g. several times, typically in a somewhat continuous manner, may also or alternatively be used for effectively increasing resolution and decreasing measurement error and noise of objects and surroundings. For example, measuring the height of the individual N times may effectively reduce the measurement error by a factor of the square root of N (under some statistical assumptions). However, such implementation may require extensive computational resources, e.g. as explained below.

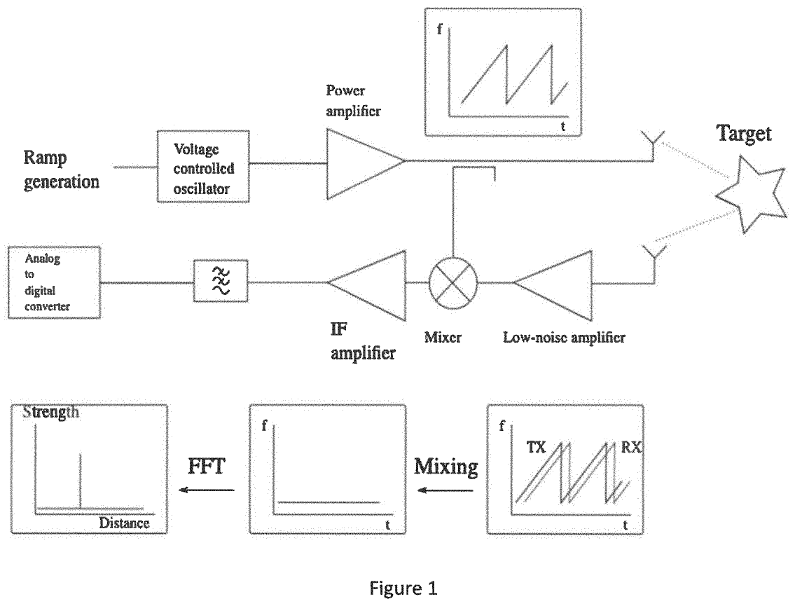

Most radars suitable for such purposes employ either (as shown in FIG. 1) FMCW (Frequency Modulated Continuous Wave) or Multi-Tone Ultra-Wideband (UWB) signaling techniques. Texas Instruments manufactures the basic components for FMCW radars (e.g. as described here www.ti.com/IWR) and IMEC for UWB radars (e.g. as described here www.imecint.com/drupal/sites/default/files/201904/8GHz%20UWB%20RADAR_FINAL.pdf). In both cases, the radar may repeatedly e.g. periodically (e.g. per measurement cycle) transmit pre-defined signal sets and then may process, in parallel, the received echoed signals e.g. as shown in FIG. 1.

The signal processing involved may be operative to transform (or translate) frequency domain measurements to time domain results, or vice versa, depending on the radar type. The reasoning for the use of such transformation functions is that radars are typically designed to measure distance through the measurement of time gaps or phase delays, while the measurements may be done either in a different domain (frequency), or may need to be indirectly derived through other processing techniques. These signal processing algorithms typically use Fast Fourier Transform supplemented with 2D and 3D constructions simulating the radar surroundings. Such techniques require significant computational power.

After the radar data is finally processed, then either Machine Learning or Deep Learning techniques may be employed for object recognition. The method may Include processing the data collected from the simulated and constructed) 2D/3D image as computed from processing the radar signals, produced for every radar measurement cycle, each cycle typically requiring significant computational resources.

Thus it would be desirable to resolve or improve either or both of the following two problems which plague conventional approaches.

Problem 1: The inherent spatial resolutions of millimeter wave radars are much coarser than optical cameras.

Problem 2: Generating data from either a 3D or 2D constructed radar image may require significant computational resources.

Certain embodiments herein resolve these issues by combining two methods described below, although, alternatively, each of the two may be used in isolation.

### Method 1

Turning to problem 1, the inherent spatial resolution limitations typically cannot be changed yet may be relaxed by imposing problem-space constraints and/or providing external sensor measurement enrichments. For example, consider an optimization process where V is a multi-dimensional variable and F(V,R) is a scalar function providing some measurement or quantification reflecting similarity between V and R where R is a reference vector. A search or optimization process searches for an Ri which will provide the highest value Fi=F(V,Ri) for a set of given set of reference vectors [R1, R2, . . . RN]. If the computation of F(V,R) requires extensive resources, and the number of dimensions of V is high, then the duration for the search process may be long, however, some of the computational requirements may be relaxed if some a priori information becomes available. For example, when through some analysis (prior to the search) it is discovered that only a few of the variable dimensions provide a meaningful impact on the search process the search efforts may be invested in or focused on or include only those dimensions. For example, if V includes the height of the object and its related body temperature, it could be that for identification purposes, the body temperature is less significant and can be weighted low or otherwise disregarded. Another example, is when a priori information is available the system typically points out the range (of the search) at which the optimal value may be found. In an example, a typical bedroom size is about 3 meters by 3 meters (or 10 ft by 10 ft) hence it is meaningless to process any range related data which extends beyond the room size (even if the room has windows and the radar may pickup external objects). It might be that for accuracy reasons the target range will be even smaller as the radar signal tends to decay over distance and the signal to noise ratio decreases as well. Another alternative is to decrease the number of reference vectors hence decrease the amount of computation needed for similarity analysis. This can be done, say, by focusing first on popular items first (e.g., family members at a given residence) and only if the search process cannot find a similar enough reference (e.g., F(V,R) for the given set doesn't produce a high enough number indicating probable similarity) then additional searches may be performed.

Specifically, and practically for this case, in many recognition use cases, the actual need may be to identify the association of an object to a pre-defined whitelist. In other words, the system may only need to determine if the object is included in a predefined list or not, yielding a valuable constraint on the problem-space. For example, given a system installed in a home, and given that a person has been detected, it may be useful or sufficient to determine whether this person is a member of the household, is s/he either Mom, Dad, Joe or Jenny, or whether this person is a stranger. There is no need to have capability to identify and classify any possible object (e.g. there is no need to determine whether the imaged person is any of billions of people), but only the objects (e.g. family members) that are on a list which is, for many use-cases, very short, is typically predefined and/or is typically of limited length.

Other associated measurements, which are not related to the radar system itself, may supply additional data (e.g. external sensor measurement enrichments) regarding the object. For example, when attempting to identify the presence of specific individuals within a room, then weight measurements which were taken by another system in a nearby location, such as another room in the same house, may complement the existing radar related data. For example, the object or person whose weight measurements were taken at time t1 may be tracked, so as to associate those weight measurements to other data measured regarding the same object, within a deltaT time interval during which the object or person is being tracked.

### Method 2

Alternatively, or in addition, the raw radar data (available prior to the signal processing stage) may be used directly for training purposes e.g. as training data. The advantage of utilizing the data at this pre-processed stage is that there is no need for intensive computational resources for every radar measurement cycle. It may be decided to perform the signal processing (typically using Fast Fourier Transform supplemented with 2D and 3D constructions simulating the radar surroundings) every Nth measurement cycle, hence reducing the computational efforts by the same factor N. Typically, data both from the raw “source” for every cycle, and from the processed and constructed source every N cycle, may be utilized.

.”

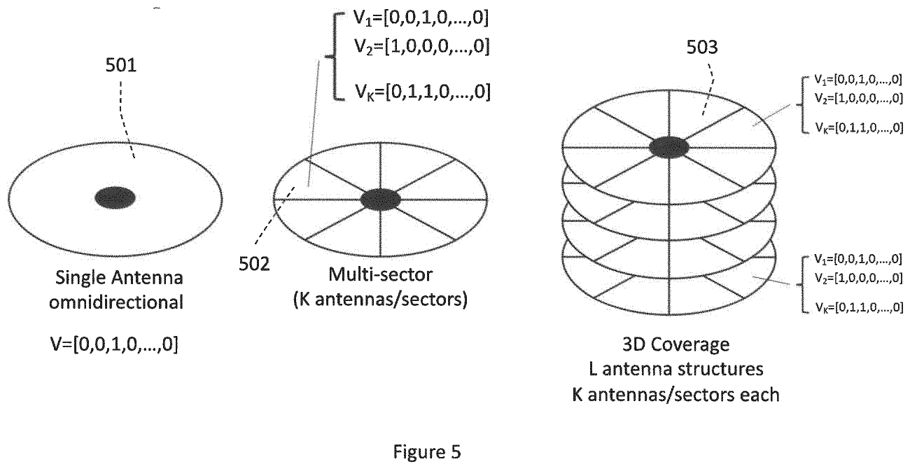

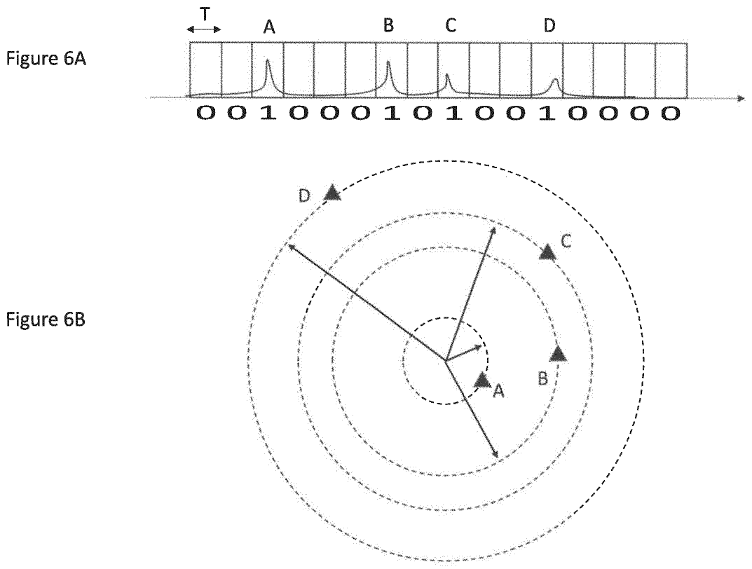

The 2D/3D construction used in the signal processing typically comprises transforming raw measurement data which is typically not related to distance (or length, area, volume etc.) to meaningful geometrical related data. For example, consider an omnidirectional, 360 degree (in azimuth) antenna transmitting and receiving signals in a narrow elevation beamwidth (501 in FIG. 5). With this setup, a short duration electromagnetic pulse may be sent and then on occasion e.g. every T seconds, the receiver detects if an echo signal (reflection from objects nearby) has been sensed, and correspondingly stores a “1” value if an echo was sensed and “0” otherwise, for each measurement time slot e.g. once every T seconds. This process may be repeated N times (at time instances T, 2T, 3T . . . NT) to yield a binary vector V of N values, [V1, V2, V3 . . . , VN] e.g. as shown in FIG. 6A. Taking a basic view of such radar system, if an object is hit with the pulse and reflects back the echo, the echo may be received at the origin point after t=2D/c seconds (where D is the distance of the object from the origin and c is the speed of light). Returning back to the vector V, the value in position Vi, actually represents the existence of an object at iT=2D/c meaning D=icT/2. As the antenna transmits at 360 degrees, this actually refers to the possibility of an object at a circular radius r, r=D=icT/2 (e.g. as shown in FIG. 6B).

If instead of one antenna, an antenna structure of K antennas are deployed, all of which may share the same height and elevation properties and may each aim at a sector of 360/K degrees (502 in FIG. 5), the system may maintain K vectors which may increase the system's resolution of detection (instead of circles the system may now evaluate sectors of 360/K each). the antennas may be used at non overlapping times to eliminate crosstalk; thus typically, while one of the antennas is in use, transmitting once and receiving for N time slots, no other antenna is in use.

If instead of one such antenna structure, L such antenna structures are provided (e.g. are stacked on a pole at L different heights respectively) this results in facilitating the possibility of sensing objects at different heights as each antenna may have but a limited narrow elevation beamwidth and be sensitive only to objects at a certain height (e.g. 503 in FIG. 5). these structures may be used in non-overlapping time periods, e.g. such that while one structure is in use, all other structures are not. Thus the system may maintain K*L vectors whose binary values may be transformed into geometry related values representing 3D object locations surrounding the antenna structure. in other practical cases the transformation from the values measured to the geometrical data may be a computational intensive process as the original data may be for example, frequency related and a Fourier transform may be used, e.g. to extract time domain properties.

Other combinations may be applicable, depending on the use case, required accuracy, and available computation power. For example, the raw source may be used every M cycle (aka measurement cycle), and the constructed source every N cycle, with some cycle shift K. In other words, while the raw source cycles used may be i, i+M, i+2M, . . . the constructed sources cycles used may be i+K, i+K+N, i+K+2N, . . . it is appreciated that the schedule of use of raw data (and/or of constructed data) need not be every such-and-such cycles. Instead, raw data may be used only for certain cycles, which may be randomly selected e.g. according to a certain distribution, and/or processed data may be used only for certain cycles, which may be randomly selected e.g. according to a certain distribution.

The data collected may be used in any suitable manner to generate object identification results. For example, the collected data may be used:

a. to collectively drive various Machine Learning or Deep Learning models Typically, a suitable feature extraction process may extract features related to the physical characteristics of the raw signal itself (e.g., peak values and/or their time occurrence, and/or energy time correlation between receivers, etc.). Features may be extracted from the raw and/or constructed data and may be provided as input to an AI model. This process may be driven by both the raw data and the constructed data. And/or
b. the data collected may independently drive different models e.g. the raw data drives one feature extraction process, and the constructed data drives another. A suitable technique e.g. Ensemble Learning techniques, such as bagging or boosting, may be used to combine the results or output of the various models, thereby to yield object identification results.

The term ensemble is intended to include any technique which derives an output based on plural typically independent models.

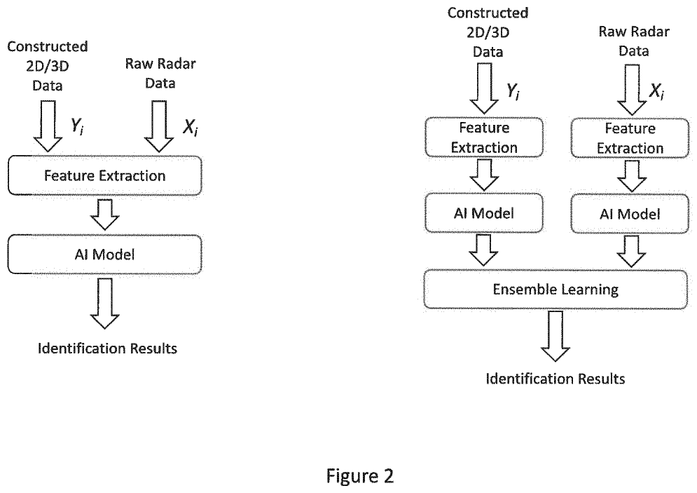

For example, in the example presented in FIG. 2, if the raw source produces the set of features X1, X2, . . . and the constructed source produces the set of features Y1, Y2, . . . , then either the models may be based on (X1, X2, . . . , Y1, Y2 . . . ) together or one model Mx may be based on (X1, X2, . . . ) and another model, My, may be based on (Y1, Y2, . . . ) and their associated outputs Zx (for Mx) and Zy (for My), may be combined by some predefined weighting function or selection process, for example F(Zₓ,Z_{y})=αZₓ+βZ_{y}.

In this example, (X1, . . . ) may represent a power measurement at a specific frequency (spectral measurements) and (Y1, . . . ) may represent an intensity measurement at a specific 2D pixel (spatial measurements).

In one embodiment, the power measurements in the frequency domain may be used together, directly, with the intensity measurements of different pixels representing some 2D area. For example, perhaps only when a certain frequency domain value is exceeded, the pixel level information is used or displayed. In another embodiment, power measurements in the frequency domain and intensity measurements of different pixels representing some 2D area, are used together for training some machine learning or deep learning model and their learning process outcome is used. For example, the learning process may be used to increase accuracy and adjust by biasing 2D or 3D previously computed values.

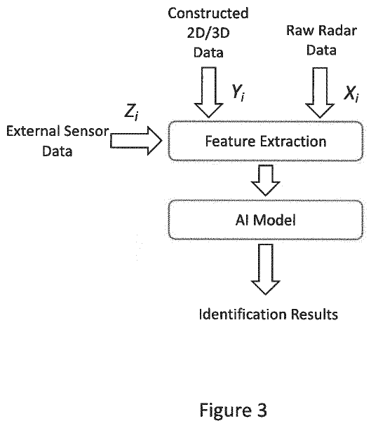

Turning now to FIG. 3, another use-case associated with recognition of people within a room is where the whitelist consists of N people, and one model based on the raw source (e.g., spectral measurements) produces a first list of scores for each person (say) on the list (the score typically represents the probability that the individual is present in the room) and another model based on the constructed source (spatial measurements) also produces a similar list of scores for each person (say) on the list. The combined result may be a simple (or weighted) average between the lists and choosing a best score e.g. the top score. For example, if the 1^{st} score list of 3 people (Alice, Bob, Charles) is (0.2,0.7,0.1) and the 2^{nd} score list is (0.5,0.1,0.4) then the simply averaged scores are (0.35,0.4,0.25) and as the 2^{nd} item is the highest score—Bob may be identified as the person in the room.

There may also, e.g. as described above, be processed data from external sensors to increase the accuracy of the identification process. In this case, a set of external data variables (Z1, Z2, . . . ) is also used. These variables are typically not tightly coupled to the data which originated from the radar measurements (or radar data), as it is not derived through the system. In addition, repetitions of external sensor measurements may be done independently of the radar measurements, if at all. For example, if Z1 represents the weight of a person as measured by some sensor in the room, then Z1 may be measured once every 10 seconds, and it does not have to be in sync with the radar measurement cycles, which may be longer or shorter than 10 sec, or not an integer multiple thereof.

Typically, the system is configured to couple between sensor measurements and radar measurements for correctly correlating the various measurements. For example, the system may use a suitable technology to determine that sensor measurements of a specific individual are related to or coupled to the radar measurements of the same person. The coupling may be achieved by event synchronization, specific to the deployment case. For example, if time stamping (time labeling) is attached to each measurement then time comparisons may be used for synchronizing different measurements from different systems. More generally, any suitable methods for time synchronization may be employed, for example as described herein: AUTHORS.LIBRARY.CALTECH.EDU/40495/.

For example, the weight sensor may be positioned at a location adjacent to the radar detection area or field of view, and when the weight sensor detects a weight change (e.g., increase from 0 KG to any weight greater than 10 KG), a trigger signal is sent to the radar system indicating that an individual is about to enter the area and the radar in response is set for a measurement phase for some period of time (e.g., 10 seconds) yielding a temporally-based correlation between weight measurements and the radar measurement. When several individuals enter the measurement area, various techniques may be used to decouple them, the techniques may be time based or spatial based; thus the occurrences of these individuals are separated either temporally or by location as may be sensed by the radar elevation and azimuth separation capabilities dictated by its antennas and signal processing capabilities.

Also, instead of, or in addition to, using a weight sensor, a physical camera may be used for correlating between images and radar scans. For example, a camera maybe installed at an outside facing door (capturing images external to a house), while radar is installed for scanning the indoor area. Sensor data (e.g., a camera) may be used for label tagging the radar measurements for a data collection and training phase of various machine learning or deep learning algorithms. Instead of (or in addition to) using the sensor data for increasing identification capabilities, sensor information is used for tagging the data (e.g. to yield training data) for the data science model tuning phase aka “data collection and training phase” which may include training of the AI models e.g. as shown in FIGS. 2, 3. for example, if a camera is used outdoors, the camera may independently identify individuals (e.g. from the whitelist) using common face recognition techniques, and tag the radar measurement data accordingly. For example, when John enters his apartment, the outdoor camera may identify John as himself and tag subsequent radar measurements (done immediately e.g. within a specified time-window after he enters his apartment) with his name, associating the radar measurements to John.

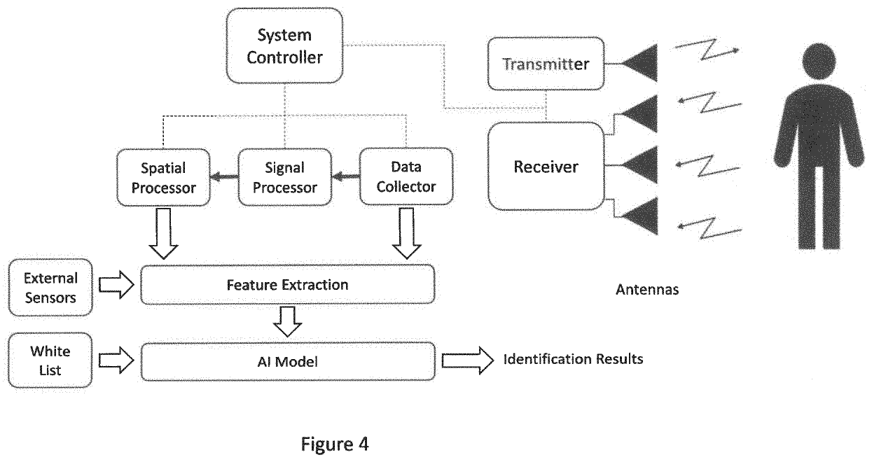

A simplified block diagram illustration of a system according to certain embodiments, which uses external sensors for feature extraction and includes an AI processor which receives at least one whitelist as an input, is shown in FIG. 4.

The embodiment of FIG. 4 may be used for a use case of identifying individuals based on a predefined whitelist. Alternatively, any subset of the illustrated blocks may be employed, for this use case, or for others.

As commanded by the system controller of FIG. 4, the radar transmits its signal through one or more transmitting antennas. In parallel, more or one receiving antennas receive the bouncing echoes. Any suitable number of antennas and location/s thereof may be used e.g. depending on the level of spatial details, and the choice of 2D or 3D required abilities.

The raw receiving data is collected and stored by the data collector of FIG. 4 and may be further processed by the signal processor and spatial processor which may each be timed and controlled by the system controller. Typically, the signal processor is configured for processing signal samples and applying digital processing techniques such as, but not limited to, filtering (e.g., emphasizing or deemphasizing certain signal aspects), and/or domain transformations (e.g., Fast Fourier Transforms) and/or stochastic analysis (e.g., statistical estimation based on signal behavior), all e.g. as described elsewhere herein. The spatial processor ay be configured for geometric representation of the surroundings—e.g. location of objects, and/or dimensions of objects, and/or states of objects (e.g., moving yes/no, sitting, standing, etc.) and/or object decoupling (e.g., object count and separation whether temporal or spatial, of more than one object is detected in some given area), all e.g. as described elsewhere herein.

The data sources for the feature extraction module of FIG. 4 include the raw data as collected by the data collector and/or the spatial processor data, and any external data received from other sensors which need not be related to the radar system. The AI processor uses at least one model for processing and analyzing the incoming data including comparing the incoming data to a predefined whitelist of individuals. The AI processor may notify the system of its identification results.

Features of the present invention, including method steps, which are described in the context of separate embodiments, may also be provided in combination in a single embodiment. Conversely, features of the invention, which are described for brevity in the context of a single embodiment or in a certain order, may be provided separately, or in any suitable sub-combination or in a different order.

Any or all of computerized sensors, output devices or displays, processors, data storage and networks, may be used as appropriate, to implement any of the methods and apparatus shown and described herein.

It is appreciated that terminology such as “mandatory”, “required”, “need” and “must” refer to implementation choices made within the context of a particular implementation or application described herewithin for clarity, and are not intended to be limiting, since in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities, e.g. software functionalities shown and described herein, may be deployed in a cloud environment. Clients, e.g. mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator, or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section, or in publications mentioned therein.

Conversely, features of the invention, including operations, which are described for brevity in the context of a single embodiment or in a certain order, may be provided separately or in any suitable sub-combination, including with features known in the art (particularly, although not limited to, those described in the Background section or in publications mentioned therein), or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof, can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.), or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include any apparatus, whether hardware, firmware or software, which is configured to perform, enable or facilitate that operation, or to enable, facilitate, or provide that characteristic.

The terms processor or controller or module or logic as used herein are intended to include hardware such as computer microprocessors, or hardware processors, which typically have digital memory and processing capacity, such as those available from, say Intel and Advanced Micro Devices (AMD). Any operation or functionality or computation or logic described herein may be implemented entirely, or in any part on any suitable circuitry, including any such computer microprocessor/s, as well as in firmware or in hardware, or any combination thereof.

It is appreciated that elements illustrated in more than one drawing, and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement, or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g. operation described herein may have all characteristics and attributes described or illustrated herein, or, according to other embodiments, may have any subset of the characteristics or attributes described herein.

It is appreciated that apps referred to herein may include a cell app, mobile app, computer app, or any other application software. Any application may be bundled with a computer and its system software, or published separately. The term “mobile” and similar used herein, is not intended to be limiting to a phone, and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus the computing device may even be disconnected from e.g., WiFi, Bluetooth etc., but may be tethered directly or ultimately to a networked device.

1. A method for generating data regarding individuals in an area of interest including:
operating a radar system, deployed in the area of interest, to provide a radar image including raw radar data; and
using a hardware processor configured to store a trained model for analyzing the radar image, thereby to generate object recognition data,
wherein said raw radar data generated by the radar system both
undergoes signal processing, thereby to generate processed radar data which is used for said training, and
is used directly, without signal processing, for training said model.

2. A method according to claim 1 wherein said signal processing is performed only every N measurement cycles, thereby to reduce computational effort by a factor of N.

3. A method according to claim 1 wherein said training includes using a training data set which includes:
“raw” data which has not undergone said signal processing, for every measurement cycle of said radar system, and
said processed radar data, from the processed and constructed source, for only one of every N measurement cycles of said radar system.

4. A method according to claim 1 wherein said training includes using a training data set which includes:
“raw” data which has not undergone said signal processing, for only one of every M measurement cycles of said radar system; and
said processed radar data, from the processed and constructed source, for only one of every N< >M measurement cycles of said radar system, with a cycle shift K relative to the M measurement cycles.

5. A method according to claim 1 and also comprising using external sensor measurement to enrich said data.

6. A method according to claim 1 wherein said radar system comprises a millimeter wave radar whose inherent spatial resolution is coarser than the inherent spatial resolution of an optical camera.

7. A method according to claim 1 wherein the data comprises a determination of whether or not a given detected individual appears on a given whitelist.

8. A method according to claim 1 wherein a physical camera is used allowing for correlation between images and radar scans.

9. A method according to claim 8, wherein 2D construction of the 2D constructed radar image is performed only every N measurement cycles, thereby to reduce computational resources required for generating data from the radar image.

10. A method according to claim 1 wherein said radar image comprises at least one of:
a 3D constructed radar image; and
a 2D constructed radar image.

11. A method according to claim 10 wherein 3D construction of the 3D constructed radar image is performed only every N measurement cycles, thereby to reduce computational resources required for generating data from the radar image.

12. A method according to claim 1 wherein Ensemble Learning is used to combine raw and constructed radar data.

13. A method according to claim 12 wherein the raw data being combined comprises at least one spectral measurement including at least one power measurement at a specific frequency.

14. A method according to claim 13 wherein the constructed data being combined comprises at least one spatial measurement including at least one intensity measurement at a specific pixel.

15. A method according to claim 13 wherein both power measurements in the frequency domain are used together with intensity measurements of different pixels representing a 2D area.

16. A method according to claim 13 wherein both power measurements in the frequency domain and intensity measurements of different pixels representing some 2D area are used together for establishing said model.

17. A computer program product, comprising a non-transitory tangible computer readable medium having computer readable program code embodied therein, said computer readable program code adapted to be executed to implement a method for generating data regarding individuals in an area of interest including:
Receiving a radar image including raw radar data, generated by a radar system deployed in the area of interest,
wherein said raw radar data generated by the radar system both undergoes signal processing, thereby to generate processed radar data which is used for said training, and
is used directly, without signal processing, for training a trained model, and
using the trained model for analyzing the raw radar data, thereby to generate object recognition data.

18. A system comprising at least one processor configured to carry out the operations of:
Receiving a radar image including raw radar data, generated by a radar system deployed in the area of interest,
wherein said raw radar data generated by the radar system both
undergoes signal processing, thereby to generate processed radar data which is used for said training, and
is used directly, without signal processing, for training a trained model, and
using the trained model for analyzing the raw radar data, thereby to generate object recognition data.

19. A method according to claim 1 wherein sensor data is used for label tagging the radar measurements for the data collection and training phase of at least one algorithm.

20. A method according to claim 1 wherein, to know that sensor measurements of a specific individual are related to the radar measurements of the same person, coupling is achieved by event synchronization.

21. A system according to claim 18 which includes a sensor e.g. weight sensor whose outputs are combined with temporally adjacent outputs of the at least one processor, thereby to yield classification of detected events as presence of an identified one of, or none of, plural objects on a whitelist, at a level of accuracy exceeding an accuracy level which would result from using the system alone, without the sensor, for said classification.

22. A system according to claim 18 which includes e.g. an optical camera with face recognition functionality which provides a label identifying a recognized face which can be used to tag radar measurements (or radar data) generated by the radar system, thereby to yield tagged training data to be used during said training.
